(19) United States
(12) Patent Application Publication
(10) Pub. No.: US 2015/0282033 A1
(43) Pub. Date: Oct. 1, 2015

(54) REVERSIBLE HANDOVER

(71) Applicant: Nokia Technologies Oy, Espoo (FI)

(72) Inventors: Jari Petteri Lunden, Espoo (FI); Elena Virtej, Espoo (FI); Lars Dalsgaard, Espoo (FI)

(73) Assignee: Nokia Technologies Oy, Espoo (FI)

(21) Appl. No.: 14/434,230

(22) PCT Filed: Oct. 26, 2012
(86) PCT No.: PCT/US2012/062291

§ 371 Date: Apr. 8, 2015

(51) Int. Cl. H04W 36/24

(52) U.S. Cl. CPC H04W 36/24

(57) ABSTRACT

Methods and apparatus, including computer program products, are provided for reversible handovers. In one aspect there is provided a method. The method may include starting a timeout period in response to an event associated with a handover of a user equipment from a source cell to a target cell; and waiting, until an expiration of the timeout period, to detach from the source cell to enable the user equipment to perform a reverse handover back to the source cell. Related apparatus, systems, methods, and articles are also described.

### FIELD

The subject matter disclosed herein relates to wireless communications and, in particular, handovers.

### BACKGROUND

In some modern wireless communication networks configured in accordance with, for example, Long Term Evolution and the like, mobility between base stations and the corresponding serving cells is performed in a radio resource connected mode using a hard handover. The hard handover refers to a handover characterized as a break-before-make type of handover because the source connection between the user equipment and the source cell is released, when a target connection to a target cell is being made, such that the user equipment is served by only one cell at any given time. Being served by only one cell at a time may refer to the user equipment receiving a signal from one cell at a time, the user equipment transmitting to one cell at a time, and/or only one cell receiving the user equipment's signal.

### SUMMARY

Methods and apparatus, including computer program products, are provided for reversible handovers. In some example embodiments, there is provided a method. The method may include starting a timeout period in response to an event associated with a handover of a user equipment from a source cell to a target cell; and waiting, until an expiration of the timeout period, to detach from the source cell to enable the user equipment to perform a reverse handover back to the source cell.

In some example embodiments, one of more variations may be made as well as described in the detailed description below and/or as described in the following features. The handover may comprise a hard handover. The user equipment may receive user data from one of the source cell or the target cell. The event may comprise at least one of a receipt of a command representative of the handover, a receipt of a command representative of the reverse handover, a completion of the handover to the target cell, an initiation of an autonomous handover by the user equipment, an initiation of an autonomous cell change by the user equipment, and an indication signaled by the network. The performing may further comprise performing the reverse handover based on at least one of the following: a quality of the target cell deteriorates, a quality of the target cell deteriorating when compared to the source cell, and a radio link failure occurs. The timeout period is at least one of received from the network, specified by a standard, or determined by the user equipment. A reverse handover command may be received from the network based on a handover decision considering at least one of the following: a speed of the user equipment, a source cell type, a target cell type, a handover history, and a quality of service class indicator for the user equipment. A first context and a second context may be maintained before the expiration of the timeout period, the first context being for a first connection between the user equipment and the source cell and the second context being for a second connection between the user equipment and the target cell. The source cell may comprise a macrocell served by a first evolved Node B base station, and the target cell may comprise a small cell served by a second evolved Node B base station. The reverse handover may be performed back to the source cell before the expiration of the timeout period.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIG. 1 depicts an example system in which a reversible handover may be performed during a timeout period, in accordance with some example embodiments;

FIGS. 2 and 3 depict examples of processes in which a reversible handover may be performed during a timeout period, in accordance with some example embodiments;

FIG. 4 depicts an example of a radio, in accordance with some example embodiments; and

FIG. 5 depicts an example of an access point, in accordance with some example embodiments.

Like labels are used to refer to same or similar items in the drawings.

### DETAILED DESCRIPTION

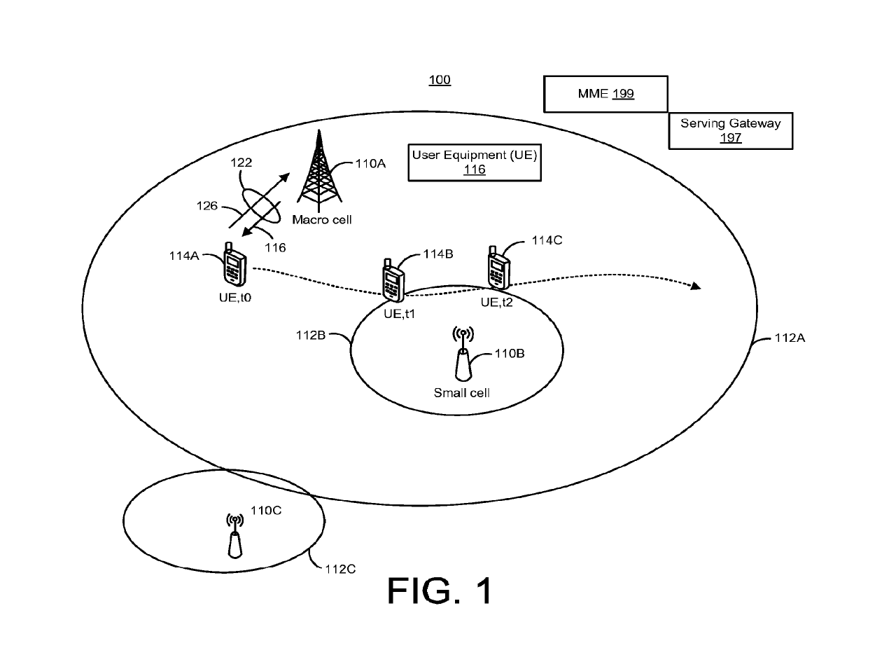

FIG. 1 depicts an example system 100 including one or more user equipment, such as user equipment 114A-C and user equipment 116. System 100 also include one or more wireless access points, such as base station 110A serving macrocell 112A via links 122, base station 110B serving small cell 112B, and base station 110C serving cell 112C, although other types of cells may be implemented as well. User equipment 114A-C represents a single, mobile user equipment (which is generally referred to herein as 114) at a first time t0 (labeled user equipment 114A), a second time t1 (labeled user equipment 114B), and a third time t2 (labeled user equipment 114C).

In the example of FIG. 1, user equipment 114A may be moving at time t0 within cell 112A and at time t1, the user equipment 114B may be handed over to base station 110B serving cell 112B, where a connection is established between the base station 110B and user equipment 114B. The decision to handover to cell 112B may, in some instances, be considered a risky or poor choice because of one or more factors. For example, the speed of the user equipment 114 as it traverses from time t0 to time t1 (as well as the relatively small size of small cell 112B) may result in a determination at time t2 that the handover to cell 112B was a mistake as reflected by a radio link failure, poor link conditions, the relatively short period of time the connection to base station 110B may be viable, and the like. When this is the case, the user equipment 114C at time t2 may, in some example embodiments, need to initiate another handover to another cell, even though the handover recently occurred. In this example, the relatively brief handover to target cell 112B may cause unnecessary signaling between the user equipment and the network, momentary loss of service, and/or degradation in the quality of service provided to the user equipment. And, in the case of heterogeneous networks including macrocells and small cells, the mobility of a relatively fast moving user equipment in a handover from the macro cell 112A to the small cell 112B may lead to a high likelihood of the connection being dropped (for example, a radio link failure) before the user equipment 114C is able to complete another handover at time t2.

Although the previous example describes the speed of the user equipment and the size of the cell as factors contributing to the inappropriate selection of cell 112B as a handover target, other factors may contribute to handover failures as well (or instead). Other examples of factors contributing to the inappropriate selection of cell 112B as a handover target may be related to the type of source cell and/or target cell (for example, a closed subscriber group, an open or hybrid cell, a cell deployed for offloading purposes, or a cell deployed for coverage purposes), the use of connected mode discontinuous receive (DRX), configuration delays, measurement reporting delays, outdated or delayed measurements, and the like. In some cases, the handover decision may be initially well justified, but later the decision may lead to problems, when the conditions worsen and the user equipment needs another handover soon after the handover to the target cell.

In some example embodiments, the subject matter disclosed herein may relate to starting a timeout period associated with a handover from a source cell to a target cell, such as a handover from macrocell 112A and small cell 112B. During the timeout period, the user equipment 114B may establish a connection to the base station 110B serving target cell 112B, but user equipment 114B may also maintain, while the timeout period has not expired, the connection (for example, maintains the context of the connection, reserving the bearers, and the like) to the source cell to allow a so-called “reverse handover” back to the source cell 112A should the handover decision to handover to the target cell 112B turn out to be a poor choice, although the network may also maintain the connection to the source as well. The timeout period may, in some example embodiments, be sufficiently long to enable the user equipment to perform a reverse handover back to the source should the handover decision to the target cell prove to be a poor choice. In any case, when the timeout period expires, the user equipment and/or network may, in some example embodiments, then detach the source connection to the source cell 112A, and, as such, the option of performing a reverse handover (also referred to herein as a reversible handover) to source cell may no longer be available to the user equipment.

In some example embodiments, the timeout period may be configured to be sufficiently long to include a first time period to allow the user equipment to implement a measurement configuration at the target cell, such as small cell 112B, and/or a second time period to allow the user equipment to perform radio measurements of the target cell (and/or detect a radio link failure (RLF)). For example, the timeout period may be configured to be long enough to allow the user equipment 114 to at least measure the small cell 112B and send a measurement report to the network, such as base station 110B.

In some example embodiments, the timeout period (implemented with for example one or more timers) for the reversible handover may start based on one or more of the following events: the user equipment receives a handover command; the user equipment initiates (for example, autonomously) a handover (or a cell change); the handover to a target cell is completed; and/or the network signals a start of the timeout period.

In some example embodiments, when handing over the user equipment from a source, macro cell to a target, small cell (or when there is some other reason to suspect that the handover may be unsuccessful), the network may not detach the source cell connection and the user equipment does not discard the source cell connection parameters. Instead, the connections to both source and target cell may be maintained simultaneously until a certain time has elapsed after the handover (for example, a time period estimated to cover the user equipment until it has been configured with new measurement configuration and some additional time to perform measurements or detect a RLF and the like). The user equipment may receive data from only one of the cells at a given time, but both of the cells may remain ready to serve the user equipment (for example, the user equipment context may be kept in cell). The timeout period may be started right after the handover procedure for a reversible handover. On a system level both the user equipment and the former source cell information may be maintained in the former source cell and the user equipment, so the user equipment and the former source cell retain, at least for the timeout period, the possibility of a return of the user equipment to the former source cell if the handover decision to the target cell turns out to be unjustified or unsuccessful (for example, the user equipment exits quickly the coverage of the small cell or the user equipment detects a RLF).

In some example embodiments, the handover command may explicitly indicate to the user equipment that the handover is reversible for a given time defined by for example a timeout period. In some example embodiments, handover signaling may explicitly indicate (for example, in the handover command) a timeout period representative of how long the former, source cell should be prepared for the user equipment to return from a reverse handover, although this timeout period may be fixed in a specification. In some example embodiments, the former, source eNB base station may maintain the user equipment context, information related to the connection between user equipment and source eNB, and/or reserve resources for the user equipment until the given time, such as the timeout period, has elapsed. In some example embodiments, if the connection to the target cell fails within the given time/timeout period (for example, due to a RLF and the like), the user equipment may first attempt to resume the connection to the former, source cell via the reverse handover. In some instances, the hard handover may have initially succeeded to the target cell, but then the user equipment may exit the coverage area of the target cell (which may be a small cell, such as for example a pico or femto cell) before a controlled handover can be triggered back to the macro cell, and this reverse handover may occur, for example, about 5 seconds after the handover to the target cell is successful, although other times may be implemented as well. As such, in some example embodiments, the macro cell may retain the user equipment's connection for a sufficiently long period of time and may inform the user equipment of this time, so that the user equipment can perform a reverse handover back to the source cell using the retained connection(s) (or context(s)) to the source cell.

In some example embodiments, the timeout period may be signaled by the network to the user equipment, although the timeout period may be specified by a standard and/or determined by the user equipment (in which case, the timeout period would be signaled to the network, for example in combination with a handover/cell change request by the user equipment). The timeout period may comprise one or more fixed values, although the timeout period may be variable and/or configurable as well. For example, the network may select the timeout value based on the size of the cell, the speed (or mobility state) of the user equipment, and/or any other factor. Example values of the timeout period include one or more of the following: about 0 seconds (which would imply no timeout period and no reversible handover), about 1 second, about 2 seconds, about 5 seconds, about 10 seconds, about 30 seconds, and/or any other time. The network may, in some example embodiments, also signal the user equipment to indicate, when the timeout period has expired, for example after user equipment's connection with the new, target cell has been established and new measurements are configured and running. This may happen before the given timeout period expires. It may also be that, in some example embodiments, no explicit timeout period is provided to the user equipment, but instead an indefinite timeout period length may be used or the timeout period may valid until the next, subsequent handover by the user equipment (thus having reversibility of only one previous handover, although a longer history may also be supported).

In some example embodiments, when a handover is made and reversible handover is used, the former, source cell connection may be maintained/retained simultaneously with the target cell connection. This may, as noted, allow reversing the handover decision to the target cell and continuing with the source cell connection, if the handover decision turns out to be a poor choice (for example, a radio link failure is detected in the user equipment and the like).

In some example embodiments, the network may determine whether to perform a reversible handover. If a decision is made to perform a reversible handover (also referred to herein as a reverse handover), the network may signal to the user equipment an indication to perform the reversible handover and/or an indication of the timeout period. For example, the network may decide that the handover is likely to be successful, so the network signals to the user equipment that the handover should proceed as a hard handover. But if the network decides, based on one or more factors, that the handover may be a poor decision, the network may signal to the user equipment that the handover to the target cell should be performed as a reversible handover, so the user equipment can keep, for the duration of the timeout period, the connection to (or alternatively have the option to resume the connection to) the source cell after the handover to the target.

In some example embodiments, the network may decide whether to perform a reversible handover based on one or more of the following factors: a speed (or mobility state) of the user equipment, a type of source cell (for example, a cell size, a transmit power, an access restriction, a radio access technology, an operating frequency/frequencies, an available bandwidth or capacity, a backhaul capability, an inter-cell signaling capability, whether the cell is deployed for offloading purposes, whether the cell is deployed for coverage purposes, and the like), a type of target cell, a handover history representative of durations, failures, and/or successes for a target cell, a handover history for a user equipment, neighbor cells of the target cell (for example, consideration of the likelihood of further successful handovers from the target cell), a quality of service class indicator (QCI) for a given user equipment, and/or any other factor indicative of whether a handover to a target cell is likely to be successful in terms of duration, quality of service, and the like.

In some example embodiments, the process of reversing the handover is initiated by the new, target cell. The reverse handover may be also initiated by the user equipment, when for example measurements indicate that the source cell would be better or the signal quality of the new target cell has deteriorated (for example, below a predefined level). If the decision to reverse the handover is made by the network, the target cell may signal the user equipment to return back to the source cell. The user equipment may then signal the source cell regarding a return to the source cell. This signaling may be accomplished by for example a scheduling request (SR), a measurement report, media access control (MAC), radio resource control (RRC) signaling (which may be specifically defined for this purpose), and/or during a random access procedure (for example, a specific random access preamble or message). Alternatively, or in addition, the network or target cell may signal the source cell to resume serving the user equipment. If the decision to reverse the handover is made by the user equipment, the user equipment may signal the source cell that the user equipment will be returning (using, for example, an SR, a measurement report, MAC, an RRC signaling indicating the return, or a specific random access preamble or message). Additionally, the target cell may be signaled as well that the user equipment is reversing the handover and returning to the source cell; this may be signaled by the user equipment or the source cell after receiving indication that the user equipment is returning.

Before providing additional examples, the following provides an example of a system framework in which some of the example embodiments described herein may be implemented.

As noted above, FIG. 1 depicts a system 100 including user equipment 114 and 116, base stations 110A-C, and cells 112A-C. Moreover, base stations 110A-C may have wired and/or wireless backhaul links to other network nodes, such as a mobility management entity (MME) 199, other base stations, a radio network controller, a core network, a serving gateway 197, and the like. The MME 199 and the serving gateway 197 may each comprise at least one processor and at least one memory including code which when executed by the at least one processor causes operations described herein with respect to those devices.

In some example embodiments, the user equipment, such as user equipment 114 and 116, may be implemented as a mobile and/or a stationary device. The user equipment may be referred to as, for example, mobile stations, mobile units, subscriber stations, wireless terminals, tablets, smart phones, or the like. The user equipment may be implemented as, for example, a wireless handheld device, a wireless plug-in accessory, or the like. In some example embodiments, the user equipment may include one or more processors, one or more computer-readable storage medium (for example, memory, storage, and the like), one or more radio access components (for example, a modem, a transceiver, and the like), and/or a user interface.

In some example embodiments, the user equipment, such as user equipment 114 and 116, may be implemented as multi-mode user devices configured to operate using a plurality of radio access technologies, although a single-mode device may be used as well. For example, user equipment 114 and 116 may be configured to operate using a plurality of radio access technologies including one or more of the following: Long Term Evolution (LTE), wireless local area network (WLAN) technology, such as 802.11 WiFi and the like, Bluetooth, Bluetooth low energy (BT-LE), near field communications (NFC), and any other radio access technologies. Moreover, the user equipment 114 and 116 may be configured to have established connections to access points using a plurality of the radio access technologies.

The base stations 110A-C may, in some example embodiments, be implemented as an evolved Node B (eNB) type base station, although other types of radio access points may be implemented as well. In some example embodiments, the base stations may be relays, mobile relays, mobile devices (or user equipment) acting as base stations for other devices, mobile devices in device-to-device connection, or other types of wireless nodes. When the evolved Node B (eNB) type base station is used, the base stations may be configured in accordance with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards). One or more of the base stations may also be configured to serve small cells, such as pico cells and/or femto cells. For example, base station 110B may be implemented as a femto cell base station serving small cell 112B, although other types of cells and access points may be used as well. One or more of the base stations may include WLAN technology, such as WiFi (for example, the IEEE 802.11 series of standards), as well as any other radio access technology capable of serving a cell (for example, a coverage area).

In some example embodiments, system 100 may include access links, such as links 122, between the base stations and user equipment. For example, access links 122 may include a downlink 116 for transmitting to user equipment 114A and an uplink 126 for transmitting from user equipment 114A to the base station 110A. The downlink 116 may comprise a modulated radio frequency carrying information, such as user data, radio resource control (RRC) messages, handover signaling (for example, handover commands, reversible handover commands, and/or a timeout period for the reversible handover), location information, and the like, to the user equipment 114A, and the uplink 126 may comprise a modulated radio frequency carrying information, such as user data, RRC messages, handover signaling, location information, measurement reports associated with handovers, and the like, from the user equipment 114A to base station 110A. The downlink 116 and uplinks 126 may, in some example embodiments, each represent a radio frequency (RF) signal. The RF signal may, as noted above, carry data, such as voice, video, images, Internet Protocol (IP) packets, control information, and any other type of information and/or messages. For example, when LTE is used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code. The subject matter described herein is not limited to application to OFDMA systems, LTE, LTE-Advanced, WiFi, or to the noted standards, specifications, and/or technologies.

Although FIG. 1 depicts a specific quantity and configuration of base stations, cells, and user equipment, other quantities and configurations of devices may be implemented as well.

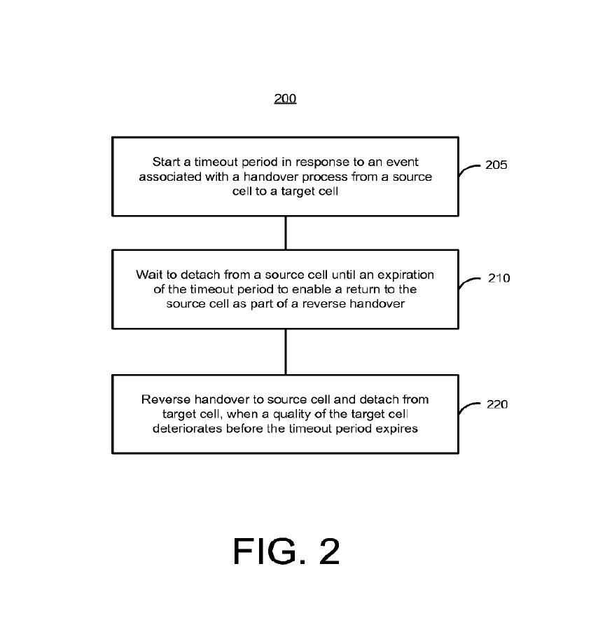

FIG. 2 depicts an example process 200 for a reversible handover performed based on a timeout period, in accordance with some example embodiments. The description of process 200 also refers to FIG. 1.

At 205, a timeout period may be started in response to an event associated with a handover process from a source cell to a target cell, in accordance with some example embodiments. For example, user equipment 114B may send to base station 110A a measurement report indicating that small cell 112B served by base station 110B may be a target for a handover. When this is the case, a handover process may be initiated to handover user equipment 114B to base station 110B and small cell 112B. Moreover, the network, such as base station 110A, may decide whether the handover should be a reversible handover. For example, if the network decides based on one or more factors that the target cell 112B represents a good handover candidate, the network may signal to the user equipment that the handover should proceed as a hard handover. However, if the network decides based on one or more factors that the handover target might be a poor choice, the network may decide to perform a reversible handover (e.g., a hard handover and while keeping the context and the like of the source connection to the source cell for a given time out period). If the reversible handover is decided, the network may send a handover command to user equipment 114B, and this handover command may include an indication that the handover to small cell 112B is to be performed as a reversible handover. Moreover, the handover command may also include an indication representative of the timeout period, during which the handover to target cell 112B is reversible to source cell 112A. When the handover command (including the reversible handover indication and/or timeout period) is received by the user equipment 114B, the user equipment 114B may establish a connection to the target cell (for example, small cell 112B) but maintain, during the timeout period, the connection to the source cell, even if the handover and connection establishment appear to be initially successful. The timeout period may, in some example, embodiments, start when the user equipment 114B receives the handover command. The timeout period may allow the user equipment 114B to recognize how long the reversible handover can be performed and how long to keep the source connection to the former, source cell 112A.

Although the previous example describes the timeout period started based on the receipt of a handover command, other events may be used to initiate the start of the timeout period. Examples of the events include one or more of the following: a completion of the handover to the target cell, an initiation of an autonomous handover by the user equipment, an initiation of an autonomous cell change by the user equipment, an indication signaled by the network, a receipt of a command representative of a handover (for example, a hard handover), and/or a receipt of a command representative of a reverse handover.

After the handover command to the target cell, the user equipment may, at 210, wait to detach from the source cell until the expiration of the timeout period to allow the user equipment to initiate a reverse handover to return to the source cell. In some example embodiments, when a handover is made to the target cell, the former source cell connection is maintained during the timeout period while another connection to the target cell connection is being used. As such, the handover decision to the target cell may be reversed, and the user equipment can fall back to the connection to the source cell, when the handover decision turns out to be a poor choice (for example, due to an RLF, poor link quality, short duration of connection, and the like) during the timeout period. For example, the handover command signaling may indicate a reversible handover and indicate the timeout period representative of how long the former source cell 112A should be prepared for a return by the user equipment 114. During this timeout period, the source cell 112A (or a node in the network, such as an eNB base station, MME 199 and the like) may maintain the context (for example, radio bearers and the like) of the user equipment 114 and/or may reserve resources for the user equipment 114 until the given timeout has elapsed (for example, defer releasing the resources/information that may be typically released after a successful handover). The user equipment 114 may thus have two connections including a source connection to the source cell (for example, to base station 110A) and a target connection to the target cell (for example, base station 110B), although data may be sent via only one connection at any given instance.

During the timeout period, the user equipment 114 may maintain synchronization and other connection information for the source cell 112A. Examples of the information that may be maintained include one or more of the following: cell radio network temporary Identifier (C-RNTI), uplink (UL)/primary uplink control channel (PUCCH) resources for the scheduling request (SR) and the channel state indication (CSI), discontinuous receive (DRX) configuration and state, cell timing information (for example, timing advance, timing advance timer (TAT)), and/or security keys of the source cell to facilitate a quick handover back. If the handover is reversed and user equipment has moved significantly, the user equipment may use random access to get resynchronized with the source cell (or any other cell).

At 220, the user equipment may detect a condition, such as the quality of the target cell, the quality of target cell compared to the source cell, a radio link failure, and the like. And, the user equipment may then decide (although the network or other nodes may decide as well) to initiate a reverse handover to return to the source cell and detach from the target cell. For example, if the connection to the target cell fails within the given timeout period (for example, due to a RLF), the user equipment 114 may attempt to resume the connection to the former source cell 112A before seeking another potential cell. Alternatively, or in addition, the user equipment 114 may attempt to resume the connection to the former source cell 112A instead of trying to re-establish connection with the target cell. If the timeout period has not elapsed and the source cell 112A is still accessible, the reverse handover may be performed to allow the user equipment 114 to quickly establish communications to the source cell 112A using the original context (for example, radio bearers, etc.) of the user equipment and/or resources allocated between the source cell 112A and the user equipment 114A.

In some example embodiments, the network or target cell may detect that user equipment is not responsive or reachable after a reversible handover. In response, the source cell may be signaled to attempt to communicate with the user equipment. This may allow, upon detecting that the quality of connection with the target cell is insufficient, the user equipment to autonomously return to the source cell and resume the connection with the source cell. Although the user equipment may also initiate the resumed connection with source cell as well.

In some example embodiments, the quality of the target cell 112B may be monitored to decide whether to implement the reverse handover based on one or more of the following: a signal-to-noise ratio (SNR), a signal-plus-interference-to-noise ratio (SINR), a reference signal, received power (RSRP), a reference signal, received quality (RSRQ), a handover event condition (for example, A3 event indicating that the target cell is no longer better than the source cell or good), a channel quality indicator (CQI), channel state information (CSI), radio link monitoring measurements, RLF monitoring, data rate, transmission error rate, cell load, and the like. In some example embodiments, the quality of the source cell 112A is monitored instead of the target cell to decide whether to implement the reverse handover. In some example embodiments, the quality of the target cell 112B may be monitored relative to other cells, such as the source cell 112A. In some example embodiments, the quality of the source cell 112A may be monitored relative to other cells, such as the target cell 112B.

In some example embodiments, if the timeout period expires and/or the serving cell is not accessible, the user equipment 114 may then seek another target cell to access and establish a connection to. In some example embodiments, if the timeout period expires, the user equipment 114 and/or network may detach the source connection between source cell 112A and user equipment 114, releasing the resources reserved for the user equipment and the downlink resources.

In some example embodiments, when the handover is reversed (if the former, source cell is successfully accessible), the user equipment may continue its connection with the source cell.

In some example embodiments, if the handover to the target cell 112B is not successful after the timeout period expires and the source cell 112A is still accessible (for example, user equipment 114 is still within range of source cell 112A), the user equipment may seek another cell, which may be the original source cell or another cell, by initiating a random access procedure to resynchronize with the cell.

After the reverse handover (if the former, source cell is accessible), the user equipment 114 may continue the source connection with the source cell 112A. Buffered downlink data may be available in both source and target cells. The user equipment 114 and/or the target cell 112B may then signal the source cell 112A that the buffered data has been received correctly (or indicate out-of-sequence uplink service data units). Alternatively, or in addition, while the connection to both source and target cells are available, the target cell 112B may keep the source cell 112A current with respect to the data for user equipment 114 (and the source cell 112A may buffer that data accordingly during the timeout period). In some example embodiments, this could be the case when there is an X2 interface between target and source cells.

To illustrate by way of another example, when a handover of user equipment, such as user equipment 114, is performed from a macro cell, such as cell 112A, to a small cell, such as cell 112B (or any other type of handover scenario that might be unsuccessful), the network may not detach the source cell connection until the expiration of the timeout period and the user equipment may not discard the source cell connection parameters until the expiration of the timeout period. Instead, the user equipment may maintain connections to both the source cell and the target cell until the timeout period (which may be started in for example after the handover to the target cell) expires. Although the user equipment may have a source connection to the source cell and a target connection to the target cell, the user equipment may be configured to receive data from only one of the cells at any given instance of time, although both of the cells remain ready to serve the user equipment (for example, the user context is kept in cell). User equipment and former, source cell information may be maintained in the former source cell and the user equipment. And, as such, the user equipment and the former, source cell may retain, at least for a given timeout period, the possibility of a return of the user equipment to the former, source cell if the handover decision turns out to be unjustified (for example, when the user equipment exits quickly the coverage of the small cell and/or user equipment detects RLF and the like).

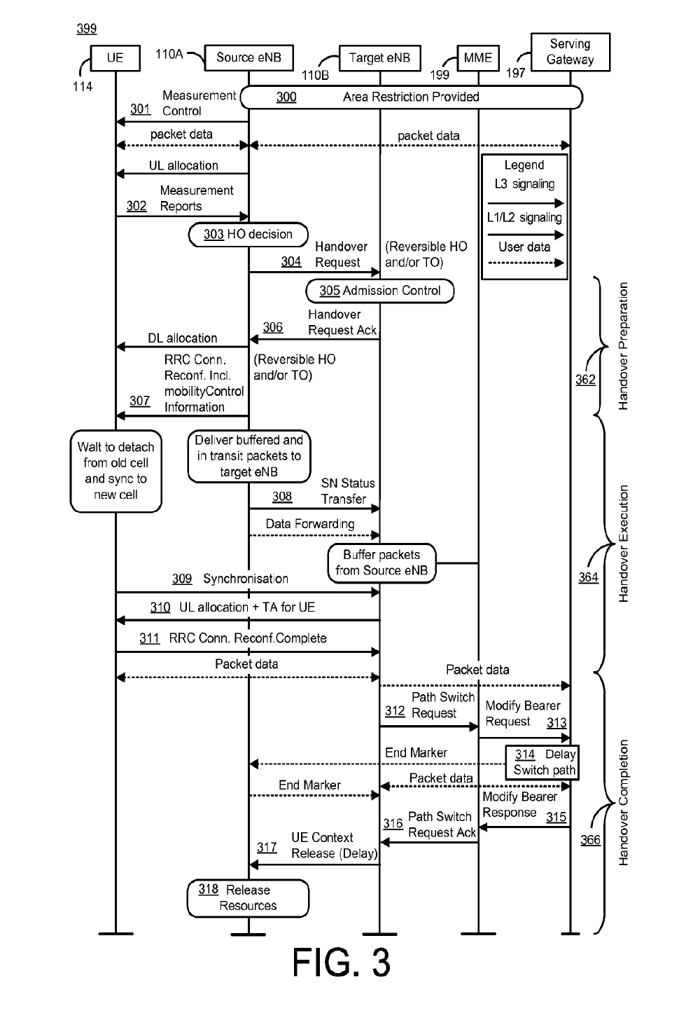

FIG. 3 depicts another example process 399 for a reversible handover performed based on a timeout period, in accordance with some example embodiments. Portions of process 399 may be in accordance with 3GPP TS 36.300 V10.5.0 (2011-09), Technical Specification: 3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 10, referred to herein as 3GPP TS 36.300), although the timeout period and reversible handover may be used with other standard-specified processes and technologies as well. The description of process 399 may also refer to FIGS. 1 and 2.

At 300, an area restriction may be provided. At 301, the network may signal to the user equipment measurement control, and, in response, the user equipment may respond with a measurement report at 302.

At 303, the network, such as source eNB base station 110A, may make a handover decision to handover from source cell 112A to target cell 112B. When this is the case, three phases may take place, namely the handover preparation phase 362, the handover execution phase 364, and the handover complete phase 366. Referring again to 303, the network may determine whether to proceed with a handover, whether the handover should proceed as a hard handover, and/or whether the handover should proceed as a reversible handover based on a timeout period, in accordance with some example embodiments.

Depending on one or more factors, the network may determine that the handover should be a reversible handover, in accordance with some example embodiments. For example, the network may consider one or more of the following when determining whether to proceed with a reversible handover based on a timeout period: a speed of the user equipment, a type of source cell (for example, whether the cell is a small cell or a macro cell), a type of target cell, a handover history representative of durations, failures and/or successes of handovers to the target cell, a handover history for a user equipment associated with the handover, a quality of service class indicator (QCI) for a given user equipment, and/or any other indication of whether the handover to a target cell is likely to be successful. To illustrate, if a target cell is a small cell and the user equipment is in a high mobility state, the network may decide to perform a reversible handover based on a timeout period. However, if a target cell is a small cell and the user equipment is in a very low mobility state, the network may decide to not perform a reversible handover as the risk of an unsuccessful handover to the target cell is lower than in the highly mobile case. Another example of a so-called “risky” handover in which the network may decide to implement a reverse handover is user equipment or a cell with a handover history including short durations, high failures, and/or few successes, all of which may indicate a reverse handover based on a time may be an appropriate decision.

At 304, the source eNB base station 110A may send a handover request to target eNB base station 110B. In some example embodiments, the handover request message sent at 304 may include information that a reversible handover based on a timeout period is requested. The message may also include a value representative of the timeout period, so the network and/or the user equipment know how long the source eNB 110A may wait for the user equipment's return as part of the reversible handover. This reversible handover information may cause the target eNB base station 110B to be configured for a reversible handover, and the reversible handover information may affect the admission control performed by the target eNB base station 110B at 305 (for example, different admission criteria may be used in the case of a reversible handover). At 306, the target eNB base station 110B may send a handover acknowledgement to the source eNB base station 110A.

In some example embodiments, the source eNB base station 110A may at 306 send to the user equipment a RRC Connection Reconfiguration including mobility control information. The mobility control information may include an information element indicating that the handover is reversible, so the user equipment can be configured to store the information of the source cell/source base station 110A (and thus in a sense wait to detach from the network at 307B) and to continue connection to the source cell/source base station 110A in case the target cell/target base station 110B is lost. Detaching may refer to, in this example, the source connection being released (for example, the user equipment and the network may release reserved resources and data going to the user equipment is no longer sent to that eNB base station). The mobility control information may also include a value of the timeout period, although the timeout period may be specified by a standard and/or determined by the user equipment, without signaling from the network.

In some example embodiments, the user equipment 114 may wait, when a reverse handover is being implemented, to detach at 307B from the source eNB base station 110B until the timeout period expires as described above with respect to 210.

At 308-316, the network may implement a process to avoid data loss during the handover. For example, in the case of a reversible handover, the target eNB 1109B may, at 312, start data forwarding to the source eNB 110A. Alternatively, the downlink (DL) path may be kept alive to both source eNB base station 110A and target eNB base station 110B until the handover is complete (for example, the timeout period expires, explicit signaling from target eNB, or the handover is reversed back to the source cell).

In 312, in case of the path switch request, when a reversible handover takes place, the target eNB may now start data forwarding to the source eNB base station. Alternatively, the downlink path may be kept alive to both source and target eNB base stations until the reversible handover is completed (for example, a timer for the timeout period expires or there is signaling from target eNB) or reversed.

At 314, the serving gateway 197 may, in some example embodiments, refrain from, or delay, sending the end marker to the source cell/source eNB 110B until the handover is completed at 317. In case of reversible handover, the target eNB 110B may instead keep forwarding data to source eNB 110A and updating the sequence number (SN) status.

At 317, the context release of the user equipment may be delayed until a timeout period has elapsed, in accordance with some example embodiments. For example, a timer may be used for the timeout period. When this is the case, after the timer expires, the target eNB 110A may stop forwarding data to the source eNB 110A (for example, by sending end marker) and may signal the user equipment 114 to discard the connection information of source eNB 110A. The target eNB 110B may also signal the serving gateway 197 that the handover is complete.

If during the handover process 399, the user equipment 114 loses a connection to the target cell/target eNB 110B, the user equipment 114 may perform a reverse handover to resume use of the connection to the source cell/source eNB 110A. And, the target cell/target eNB 110B may also issue a command for a quick handover back to the source cell/source eNB 110A, when the connection quality deteriorates or is insufficient as well. In some example embodiments, if the target cell's quality decreases too much during the timeout period, the handover may be reversed; otherwise, the source cell may release resources reserved for the user equipment and the downlink path to source cell may be removed.

In some example embodiments, error handling may be provided. For example, if the source eNB 110A is not longer accessible when the user equipment 114 attempts to return as part of the reversible handover, the user equipment 114 may initiate a random access procedure to establish a new radio link. In case of error handling, if the source cell disappears or is inaccessible during the timeout period and the user equipment tries to resume the connection, then the user equipment may initiate radio link failure recovery.

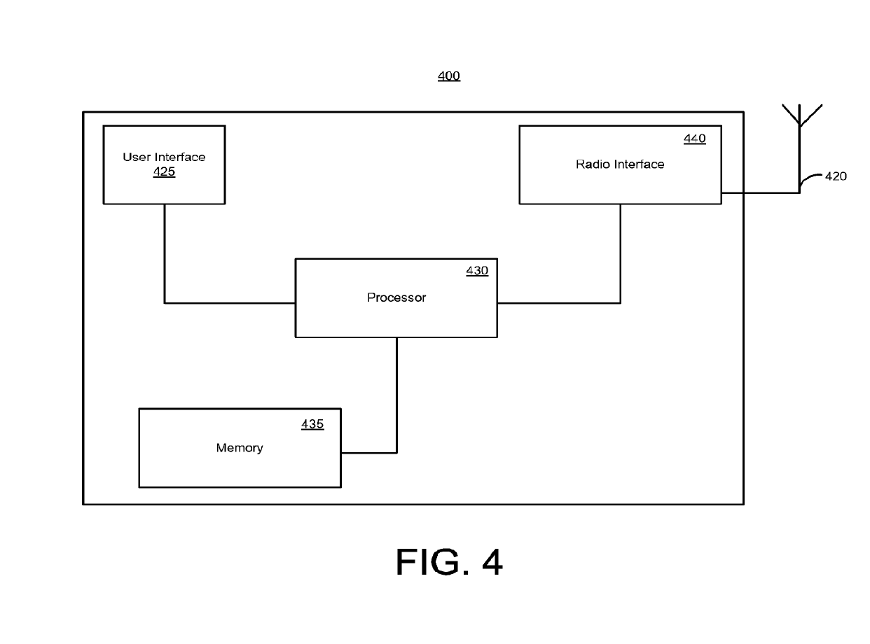

FIG. 4 depicts a block diagram of a radio, such as a user equipment 400. The user equipment 400 may include one or more antennas 420 for receiving a downlink and transmitting via an uplink. The user equipment 400 may also include a radio interface 440 (also referred to as a modem) coupled to the antenna 420. The radio interface 440 may correspond to a plurality of radio access technologies including one or more of LTE, WLAN, Bluetooth, BT-LE, NFC, RFID, UWB, ZigBee, and the like. The radio interface 440 may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink. The user equipment 400 may further include a user interface 425, at least one processor, such as processor 430, for controlling user equipment 400 and for accessing and executing program code stored in memory 435. In some example embodiments, the memory 435 includes code, which when executed by at least one processor causes one or more of the operations described herein with respect to user equipment, such as process 200, process 300, and the like. For example, the user equipment may receive a handover command and/or a reverse handover command, receive a timeout period indicating how long the user equipment can perform a reverse handover back to a source cell, store a context for a source cell, maintain a source cell connection after a handover to a target cell, and/or perform any other operations associated with the user equipment disclosed herein.

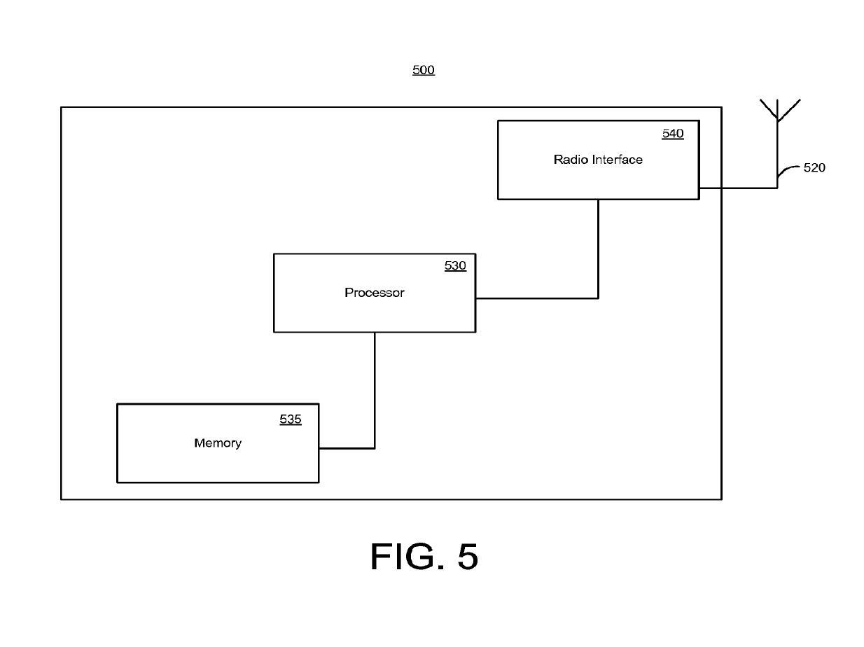

FIG. 5 depicts an example implementation of an access point 500, which may be implemented at devices 110A-C. The access point may include one or more antennas 520 configured to transmit via a downlink and configured to receive uplinks via the antenna(s) 520. The access point may further include a plurality of radio interfaces 540 coupled to the antenna 520. The radio interfaces may correspond to a plurality of radio access technologies including one or more of LTE, WLAN, Bluetooth, BT-LE, NFC, radio frequency identifier (RFID), ultrawideband (UWB), ZigBee, and the like. The access point may further include one or more processors, such as processor 530, for controlling the access point 500 and for accessing and executing program code stored in memory 535. In some example embodiments, the memory 535 includes code, which when executed by at least one processor causes one or more of the operations described herein with respect to an access point. The radio interface 540 may further include other components, such as filters, converters (for example, digital-to-analog converters and the like), mappers, a Fast Fourier Transform (FFT) module, and the like, to generate symbols for a transmission via one or more downlinks and to receive symbols (for example, via an uplink). Furthermore, the access point 500 may be configured to send a handover command, reversible handover command, and/or a timeout period for the reversible handover to user equipment, maintain a source connection (or its context and the like) during a timeout period, delete the source connection (or its context and the like) when the timeout period expires, and/or perform any other operations associated with the access point disclosed herein.

Without in any way limiting the scope, interpretation, or application of the claims appearing herein, a technical effect of one or more of the example embodiments disclosed herein may, in some example implementations, comprise reducing loss of service and other issues related to poor handover decisions and/or increasing handover reliability as the user equipment can safely return to the source cell if the handover decision turns out to be unjustified. Moreover, a technical effect of one or more of the example embodiments disclosed herein may, in some example implementations, comprise fewer radio link failures for highly mobile, fast moving user equipment. In addition, a technical effect of one or more of the example embodiments disclosed herein may, in some example implementations, comprise small cell handovers with less handover failure risk. Furthermore, a technical effect of one or more of the example embodiments disclosed herein may, in some example implementations, comprise additional offloading to small cells due to earlier and/or more frequent handovers to the small cells.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

The different functions discussed herein may be performed in a different order and/or concurrently with each other. Furthermore, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments of the invention, these descriptions should not be viewed in a limiting sense. Rather, there are several variations and modifications which may be made without departing from the scope of the present invention as defined in the appended claims. The term “based on” includes “based on at least.”

1-22. (canceled)

23. A method, comprising:
starting a timeout period in response to an event associated with a handover of a user equipment from a source cell to a target cell,
wherein the event comprises at least one of a receipt of a command representative of the handover, a receipt of a command representative of the reverse handover, a completion of the handover to the target cell, an initiation of an autonomous handover by the user equipment, an initiation of an autonomous cell change by the user equipment, and an indication signaled by the network and
waiting, until an expiration of the timeout period, to detach from the source cell to enable the user equipment to perform a reverse handover back to the source cell.

24. A method as in claim 23, wherein the user equipment receives user data from one of the source cell or the target cell.

25. A method as in claim 23, wherein the performing further comprises:
performing the reverse handover based on at least one of the following: a quality of the target cell deteriorates, a quality of the target cell deteriorating when compared to the source cell, and a radio link failure occurs.

26. A method as in claim 23, wherein the timeout period is at least one of received from the network, specified by a standard, or determined by the user equipment.

27. A method as in claim 23 further comprising:
receiving a reverse handover command from the network based on a handover decision considering at least one of the following: a speed of the user equipment, a source cell type, a target cell type, a handover history, and a quality of service class indicator for the user equipment.

28. A method as in claim 23 further comprising:
maintaining, before the expiration of the timeout period, a first context and a second context, the first context being for a first connection between the user equipment and the source cell and the second context being for a second connection between the user equipment and the target cell.

29. A method as in claim 23, wherein the source cell comprises a macrocell served by a first evolved Node B base station, and wherein the target cell comprises a small cell served by a second evolved Node B base station.

30. A method as in claim 23 further comprising:
performing the reverse handover back to the source cell before the expiration of the timeout period.

31. An apparatus comprising:
at least one processor; and
at least one memory including computer program code for one or more programs, the at least one processor, the at least one memory, and the computer program code configured to cause the apparatus to at least:
start a timeout period in response to an event associated with a handover of a user equipment from a source cell to a target cell,
wherein the event comprises at least one of a receipt of a command representative of the handover, a receipt of a command representative of the reverse handover, a completion of the handover to the target cell, an initiation of an autonomous handover by the user equipment, an initiation of an autonomous cell change by the user equipment, and an indication signaled by the network; and
wait, until an expiration of the timeout period, to detach from the source cell to enable the user equipment to perform a reverse handover back to the source cell.

32. An apparatus as in claim 31, wherein the user equipment receives user data from one of the source cell or the target cell.

33. An apparatus as in claim 31, wherein the apparatus is further configured to perform the reverse handover based on at least one of the following: a quality of the target cell deteriorates, a quality of the target cell deteriorating when compared to the source cell, and a radio link failure occurs.

34. An apparatus as in claim 31, wherein the timeout period is at least one of received from the network, specified by a standard, or determined by the user equipment.

35. An apparatus as in claim 31, wherein the apparatus is further configured to at least:
receive a reverse handover command from the network based on a handover decision considering at least one of the following: a speed of the user equipment, a source cell type, a target cell type, a handover history, and a quality of service class indicator for the user equipment.

36. An apparatus as in claim 31, wherein the apparatus is further configured to at least:
maintain, before the expiration of the timeout period, a first context and a second context, the first context being for a first connection between the user equipment and the source cell and the second context being for a second connection between the user equipment and the target cell.

37. An apparatus as in claim 31, wherein the source cell comprises a macrocell served by a first evolved Node B base station, and wherein the target cell comprises a small cell served by a second evolved Node B base station.

38. An apparatus as in claim 31, wherein the apparatus is further configured to at least:
perform the reverse handover back to the source cell before the expiration of the timeout period.

39. A computer-readable medium encoded with instructions that, when executed by a processor, perform at least the following:
starting a timeout period in response to an event associated with a handover of a user equipment from a source cell to a target cell,
wherein the event comprises at least one of a receipt of a command representative of the handover, a receipt of a command representative of the reverse handover, a completion of the handover to the target cell, an initiation of an autonomous handover by the user equipment, an initiation of an autonomous cell change by the user equipment, and an indication signaled by the network; and
waiting, until an expiration of the timeout period, to detach from the source cell to enable the user equipment to perform a reverse handover back to the source cell.
